(19) United States
(12) Patent Application Publication
(10) Pub. No.: US 2012/0297059 A1
(43) Pub. Date: Nov. 22, 2012

(54) AUTOMATED CREATION OF MONITORING CONFIGURATION TEMPLATES FOR CLOUD SERVER IMAGES

(75) Inventor: Richard A Bross, Hollis, NH (US)

(73) Assignee: SILVERSPORE LLC, Hollis, NH (US)

(21) Appl. No.: 13/429,636

(22) Filed: Mar. 26, 2012

Related U.S. Application Data
(60) Provisional application No. 61/488,195, filed on May 20, 2011.

(51) Int. Cl. G06F 15/173

(52) U.S. Cl. 709/224

(57) ABSTRACT

Monitoring configurations for monitoring systems are automatically created for cloud server instances by polling the cloud controller to detect creation of each new instance, obtaining the image ID for the new instance from the cloud controller, and using a monitoring configuration template associated with the image ID to create the monitoring configuration. If a monitoring configuration template is not available for the image ID, a new template is created, either manually and/or automatically, and added to the template database. Automated template creation can include polling and analyzing instance ports and/or detecting and interrogating embedded monitoring agents such as WMI or SNMP. Monitor packs including detection criteria and interrogation checks can be used to detect monitoring agents and construct appropriate templates. Embodiments further monitor the cloud controller to detect termination of instances, and remove corresponding monitoring configurations from the monitoring to avoid generating false alerts.

### RELATED APPLICATIONS

This application claims the benefit of U.S. Provisional Application No. 61/488,195, filed May 20, 2011, which is herein incorporated by reference in its entirety for all purposes.

### FIELD OF THE INVENTION

The invention relates to cloud computing, and more particularly, to methods for creating monitoring configurations based on cloud server images and provisioning templates and their associated instances.

### BACKGROUND OF THE INVENTION

The size and complexity of computing networks and data centers has grown rapidly in recent years, and the number of servers and other devices included in many networks and data centers has expanded greatly. As the sizes and costs of computing systems and data centers have increased, it has become highly important to use computing resources as efficiently as possible. To this end, large computing systems typically utilize IT infrastructure monitoring systems which closely monitor devices on the network so as to detect any failures which may occur, and to determine and ensure service availability.

A monitoring system can monitor a server in at least two ways, using a proprietary software agent installed on the server or via monitoring of communications to and from the device, including both passive monitoring of communications between devices, and by actively transmitting packets to the device and analyzing the responses. For example, to determine the status of a web server, monitoring software may periodically generate an HTTP request. To determine the status of an email server, monitoring software may send a test message through SMTP and retrieve it by IMAP or POP3, or otherwise interact with a service using known protocols.

Proprietary solutions typically use a software agent or protocol (referred to herein generically as an “embedded agent” or simply an “agent”) running on the monitored device. Some agents use open standards such as SNMP (Simple Network Management Protocol) or published protocols such as Microsoft's Windows Management Instrumentation (WMI). Proprietary agents are tied to specific infrastructure monitoring software. Typically, the proprietary agent will compile an inventory of device characteristics and configuration data into a Configuration Management Database (CMDB),

Generally, a monitoring system requires a specific configuration for each device to be monitored. Typically, each monitoring configuration includes information about the device itself, about its configuration (such as the operating system being used), and about the services which have been implemented on the device. In addition, monitoring configurations typically include user preferences as to what features and/or services should be monitored, how frequently various checks should be performed, and how the system should react to alerts when they occur.

For many monitoring systems, monitoring configurations for servers must be created manually by support personnel as services and software are added, removed, and reconfigured. Manual creation and maintenance of server monitoring configurations can be tedious, time consuming, and costly however, for a traditional network or data center the required effort is somewhat limited because the monitored servers tend to be highly stable, since service availability is the main goal. This places a premium on making only the configuration and infrastructure changes necessary to keep the network functioning properly. Therefore, while manual configuration can be burdensome and costly, many operators of large, traditional networks and data centers are able and willing to devote the time needed to maintain a manually configured infrastructure monitoring system.

Efforts have been made to automate the process of creating device and server specific monitoring configurations. Some monitoring systems can scan networks in an attempt to discover new devices. When a device of a known type is discovered, some of these monitoring systems are able to create a simple monitoring configuration according to certain basic features known to be included in all devices of that type, and according to pre-defined user preferences (policy based configuration). However, two servers of the same basic type may be configured very differently, so that this approach fails to include many important features and services in the automatically created monitoring configurations.

In some cases, monitoring systems can automatically create more complete and comprehensive monitoring configurations by polling the ports of each discovered device in an attempt to determine what services are being provided.

In addition, some monitoring systems use embedded agents or protocols to gather information about devices and record the information in a CMDB which can be used by the monitoring system. The embedded agent can be a standard agent such as WMI or SNMP, or it can be an agent which is specific to the monitoring system. For traditional networks and data centers where the monitoring system and all of the devices are under control of a common IT group, this approach can be acceptable and straightforward to implement, both for standard and for proprietary agents.

Some monitoring systems maintain a database of monitoring configuration templates from which monitoring configurations can be quickly created. When a new device is discovered, they attempt to select the best template from the database of templates based on known characteristics of the new device. For servers this may include characteristics in an inventory database updated by an embedded agent. Other monitoring systems apply a “one-size-fits-all” template to all devices of a given type (such as to all servers).

In recent years, “cloud computing” has become a significant alternative to traditional networks and data centers. In a computing cloud, a pool of hardware assets supports the computing needs of a large number of users by creating virtual “instances” of servers which are typically accessed by the users or by a business's employees over the internet. The virtual instances are created as they are needed, and then terminated when they are no longer of use. A given hardware asset can be used to simultaneously create many different types of virtual instance servers for many different purposes, and different hardware assets in different locations can be used to provide the same support to the same user groups at different times, depending on asset availability at any given time. In this way, the assets of the computing cloud can be used very efficiently, while at the same time providing a wide variety of services to users.

Typically, a cloud infrastructure comprises a cloud controller, a pool of physical assets, and a database of server “images” or provisioning “templates” wherein each image or provisioning template defines the characteristics of a server which is available for instantiation. While some images may be provided by the operators of the cloud infrastructure, cloud images are most often created and supplied by the users. When a virtual server is needed, it is created as an instance of a selected image.

It is important to monitor the virtual server instances of a cloud infrastructure for all the same reasons that make it important to monitor traditional servers on traditional networks and data centers. However, a cloud infrastructure poses special monitoring challenges which do not apply to a traditional network. In particular, instances in a cloud infrastructure are created very frequently, making it virtually impossible to manually create monitoring configurations for each instance. Of course, instances are also terminated very frequently. If traditional monitoring systems were applied to cloud infrastructures, this could cause a large number of alerts to be issued, since traditional monitoring systems do not expect servers to disappear frequently and suddenly, and could misinterpret the sudden unavailability of an instance as a failure of the server.

The use of embedded agents in cloud infrastructures is also more problematic than it is in traditional networks and data centers for a number of reasons. Cloud server images may be shared between multiple organizations. When using a public cloud, it may not be feasible for an agent to communicate with a monitoring system's management station over the Internet. Most Configuration Management Databases (CMDB's) are not designed to store information for transitory servers that only “live” temporarily and are then replaced. If the cloud customer is using the services of a public cloud service provider, they may not have the option of running an agent or they may be concerned about data security and software compatibility. Indeed, the cloud provider may be reluctant to make such a request of their users.

For some public cloud infrastructures, a limited monitoring service is provided by the cloud infrastructure operators from which basic information can typically be obtained about the creation and termination of instances, as well as information regarding a few generic metrics such as CPU and memory usage. However, these approaches typically fall far short of providing the level of detailed monitoring that is expected in traditional networks and data centers.

Some attempts have been made to apply automatically configured monitoring to cloud infrastructures. These automated monitoring systems typically apply generic monitoring configurations and/or templates to new instances as they are created. Proprietary embedded agents are typically not used, although information is sometimes obtained from standard agents such as WMI and SNMP, when available, for fine-tuning the monitoring configurations. However, the configuration details provided by these monitoring systems tends to be very limited compared to monitoring systems which monitor traditional networks and data centers.

What is needed, therefore, is a software-implemented method for rapid, automated creation of monitoring configurations for discrete images in a cloud computing network, thereby allowing the instances to be comprehensively monitored with a level of detail typical of device monitoring on traditional networks and data centers, while avoiding generation of false alerts when instances are terminated.

### SUMMARY OF THE INVENTION

The present invention is a software-implemented method for rapid and automated creation of monitoring configurations for server instances in a cloud computing infrastructure. The method of the present invention maintains a plurality of monitoring configuration templates which can be used to rapidly create monitoring configurations. Each of the monitoring configuration templates is associated with a server image used by the cloud to create server instances. In embodiments, a unique image ID is associated with each of the images, and each of the monitoring configuration templates is associated with an image ID.

By synchronizing with the cloud controller, the software takes note of each time a server instance is created or terminated in the cloud. When a new server instance is created, the software of the present invention obtains identifying information from the cloud controller regarding the image or provisioning template that was used to create the server instance. In embodiments, the software obtains the image or template ID from the cloud controller. The software then reviews the monitoring configuration templates to determine if any of them is associated with the identified server image.

If a matching monitoring configuration template is found, the matching template is used to create a monitoring configuration for the new instance. If a matching monitoring configuration template is not found, a new monitoring configuration template is created for the new instance. The new template is then used to create a monitoring configuration for the new instance, and the new monitoring configuration template is added to the plurality of monitoring configuration templates maintained by the software. The new monitoring configuration template can then be used to create monitoring configurations for new instances created subsequently from the same image or provisioning template.

In embodiments, when an instance is terminated in the cloud, the software of the present invention terminates monitoring of the instance without generating false alerts.

In some embodiments, when a matching monitoring configuration template is not found, the new monitoring configuration template is created manually. In other embodiments, when a matching monitoring template is not found, the new monitoring configuration template is created automatically. In certain of these embodiments, automatically creating the new monitoring configuration template includes polling and analyzing ports of the new server instance. In some of these embodiments, automatically creating the new monitoring configuration template includes communicating with the instance via a standard management protocol (referred to herein generically as an “embedded agent” or simply an “agent”) such as WMI, SNMP, ws-man, CIM/SMASH or a proprietary Web based protocol, and automatically determining if stored credentials can be used to communicate with the agent. In yet other of these embodiments, an embedded agent is not used in automatically creating the new monitoring configuration template.

The present invention is non-transient media comprising software which, when executed on a computing system, causes the computing system to execute steps leading to creation of a monitoring configuration usable by a monitoring system for monitoring an instance in a cloud computing network, the instance being created by a cloud controller according to an image or provisioning template. The steps executed by the computing system under control of the software comprising include maintaining a database of monitoring configuration templates, each monitoring configuration template being associated with an image or provisioning template, obtaining from the cloud controller information indicating that a new instance has been created using an image or provisioning template, obtaining from the cloud controller information identifying the image or provisioning template used for creating the new instance, and determining if any of the monitoring configuration templates stored in the database of monitoring configuration templates is associated with the image or provisioning template used for creating the new instance, if none of the monitoring configuration templates stored in the database of monitoring configuration templates is associated with the image or provisioning template used for creating the new instance, creating a new monitoring configuration template, associating the new monitoring configuration template with the image or provisioning template used for creating the new instance, adding the new monitoring configuration template to the database of monitoring configuration templates, using the monitoring configuration template that is associated with the image or provisioning template used for creating the new instance to create a monitoring configuration associated with the new instance, and providing the monitoring configuration associated with the new instance to the monitoring system.

In embodiments, the information identifying the image or provisioning template used for creating the new instance includes an image ID or provisioning template ID.

In some embodiments the steps further comprise obtaining from the cloud controller at least one of a private and a public IP address assigned to the new instance. In some of these embodiments creating a monitoring configuration for the new instance includes inserting the IP address into the monitoring configuration template that is associated with the image or provisioning template used for creating the new instance.

In various embodiments the steps further include obtaining from the cloud controller information indicating that an instance has been terminated and removing the monitoring configuration associated with the terminated instance from the monitoring system, thereby avoiding an issuing by the monitoring system of a false alert regarding the terminated instance.

In certain embodiments creating a new monitoring configuration template includes providing to the computing system by a user of information regarding the image or provisioning template used for creating the new instance.

In embodiments creating a new monitoring configuration template includes using a discovery process to automatically discover information regarding the new instance. In some of these embodiments the discovery process includes querying ports of the new instance and analyzing responses therefrom. In other of these embodiments the discovery process includes detecting an embedded agent running on the instance and obtaining configuration information from the embedded agent. In some of these embodiments detecting the embedded agent includes receiving from a user credentials for the embedded agent and submitting the credentials to the new instance. In other of these embodiments the embedded agent is an SNMP agent. In still other of these embodiments the embedded agent is a WMI agent. In yet other of these embodiments the embedded agent is a ws-man agent. In still other of these embodiments the embedded agent is a CIM/SMASH agent. And in yet other of these embodiments the embedded agent is a proprietary agent.

In other embodiments where creating a new monitoring configuration template includes using a discovery process to automatically discover information regarding the new instance, the steps further include maintaining at least one monitor pack, the monitor pack including detection criteria useful for detecting an embedded agent running on an instance, the monitor pack further including checks useful for interrogating the embedded agent if it is found, using the monitor pack to determine if the embedded agent is running on the new instance, and if the embedded agent is running on the new instance, incorporating the monitor pack checks into the new monitoring configuration template.

In various embodiments communicating with the cloud controller includes using an API. And in some of these embodiments the API is the Amazon EC2 API.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a functional diagram illustrating a typical cloud computing network architecture;

FIG. 2 is a functional diagram illustrating an embodiment of the present invention; and

FIG. 3 is a functional diagram illustrating interrelationships between elements of the present invention, a cloud controller, and monitoring software.

### DETAILED DESCRIPTION

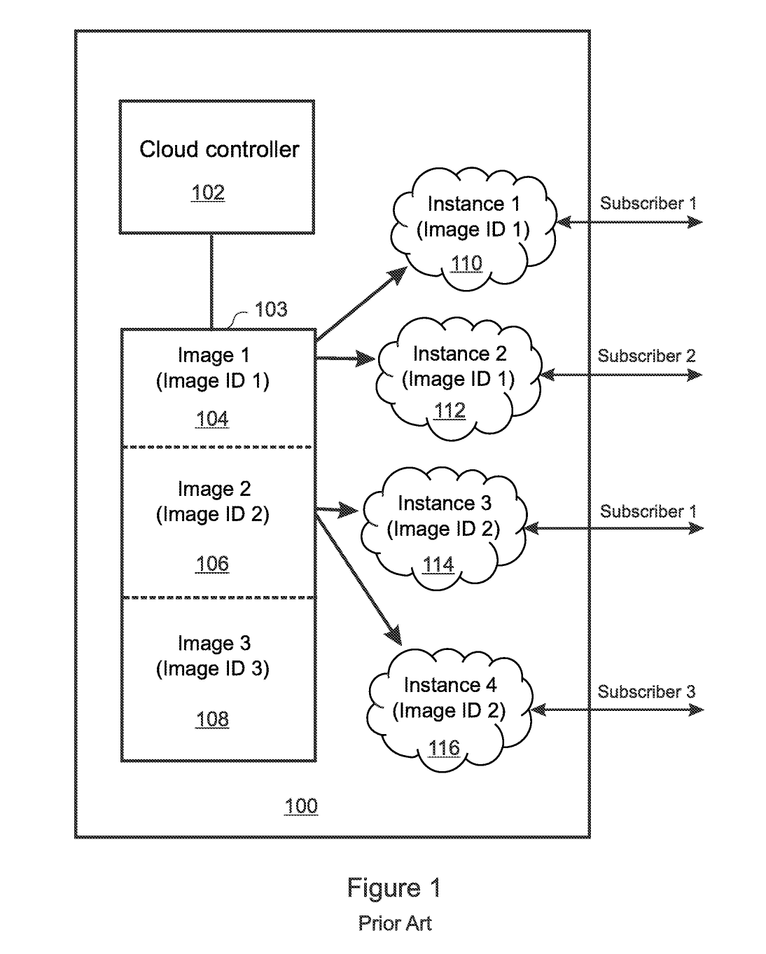

With reference to FIG. 1, the present invention is a software method for rapidly and automatically creating monitoring system configurations for monitoring virtual server instances 110-116 in a cloud infrastructure 100. In a typical cloud infrastructure 100, the computing needs (such as e.g. web hosting) of a large number of subscribers (illustrated in the figure as Subscriber 1-3) are supported by creating virtual server “instances” 110-116. The virtual instances 110-116 are created as they are needed by a cloud controller 102, and then terminated when they are no longer required. The instances 110-116 only exist when and for as long as they are needed.

A given hardware asset (not shown) can be used to create many different types of virtual instances 110-116 for many different subscribers, and different hardware assets in different locations can be used to provide the same service to the same subscriber at different times, depending on asset availability at any given time. In this way, the resources of the cloud infrastructure 100 can be used very efficiently, while at the same time providing a wide variety of services to users.

Typically, a cloud infrastructure 100 comprises a cloud controller 102 and a plurality of server “images” or “server templates” 104-108 stored in an image library 103, whereby each image 104-108 defines the characteristics of a server which is available for instantiation. While some images 104-108 may be provided by the operators of the cloud infrastructure 100, cloud images 104-108 are frequently supplied by the subscribers or are publically available.

When a virtual server 110-116 is needed, it is created as an instance of an image 104-108 selected from the image library 103. In FIG. 1, Image 1 104 has been used to create two instances 110, 112. Image 2 106 has been used to create two instances to serve a different function 114, 116. At the precise moment illustrated by the figure, no instances have been created using Image 3 108. However, FIG. 1 represents a snapshot in time, which can be expected to change frequently, since instances are typically created and terminated dynamically in a cloud infrastructure. Note that each instance 110-116 is associated with an image ID which identifies the server image 104-108 used to create the instance 110-116.

Since every instance 110-116 in the cloud 100 is created from an identifiable image or provisioning template 104-108, two instances (e.g. 110, 112) created from the same image or template (e.g. 104) will be identical in configuration. This feature is unique to cloud infrastructures and has no analog in traditional networks and data centers, where each device typically has a unique configuration. Since prior art approaches have mainly attempted to apply traditional monitoring software to cloud infrastructures, these prior art approaches have failed to take advantage of the unique features of cloud infrastructures.

The present invention exploits the unique features of a cloud infrastructure by creating and maintaining a database of monitoring configuration templates, wherein each monitoring configuration template is associated with a unique server image 104-108 in the cloud. This approach eliminates the need to create a monitoring configuration “from scratch” each time a new instance is created.

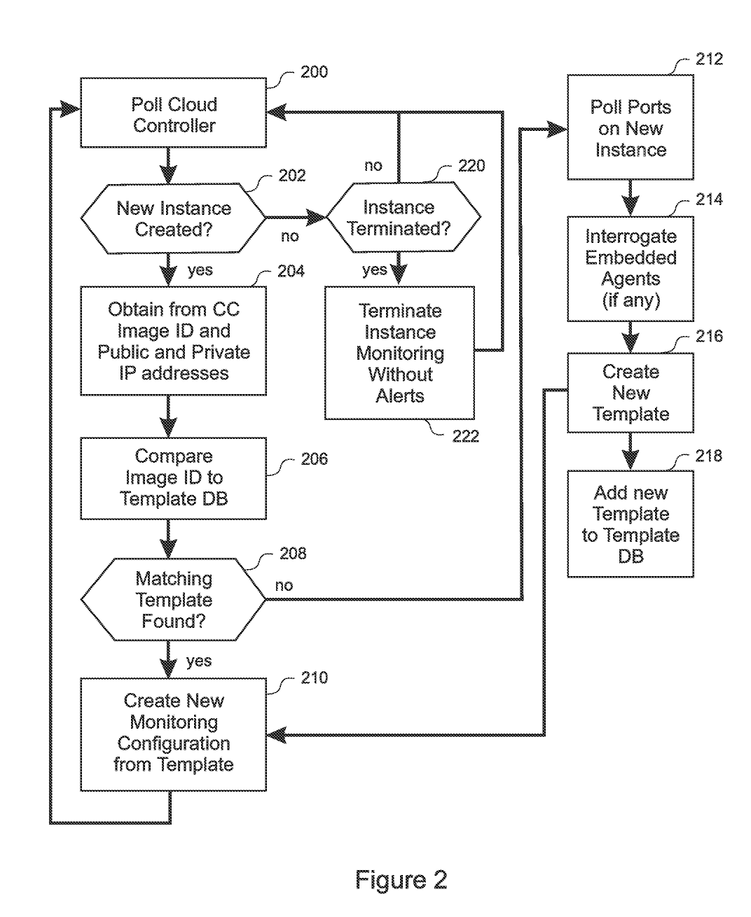

With reference to FIG. 2, in embodiments the software implemented method of the present invention includes interfacing with the cloud controller 200 to determine if a new instance has been created 202. Whenever a new instance is created 202, the image ID or provisioning template ID and the private and public IP addresses for the new instance are obtained from the cloud controller 204. The software then compares the image ID of the new instance with the image ID's associated with the monitoring configuration templates in the database of monitoring configuration templates 206. If a match is found 208, then the matching monitoring configuration template is used to create a monitoring configuration for the new instance 210, typically by inserting parameters unique to the instance (for example the public or private IP address) into the monitoring configuration template. The monitoring configuration is then provided to the monitoring software 224 for monitoring of the new instance and the monitoring system is notified of a configuration change.

If a matching monitoring configuration template is not found, indicating that the image ID or provisioning template ID has not been previously encountered, then a new monitoring configuration template is created 216 and then used to create a monitoring configuration for the new instance 210. The new monitoring configuration template is also stored 218 in the monitoring configuration template database for future use when new instances are created using the same server image or provisioning template.

In some embodiments, the new monitoring configuration template can be created manually, for example if details regarding the image are available to personnel associated with operation of the monitoring system. FIG. 2 illustrates an embodiment in which the new monitoring configuration template is created automatically, using steps which are similar to steps used to automatically create monitoring configurations for devices on traditional networks and data centers. If the image ID or provisioning template ID has not been previously encountered, the software executes a discovery process on the instance to create a monitoring configuration template for the associated image ID. In the embodiment of FIG. 2, the software uses either the public and/or private IP address(s) obtained from the cloud controller 204 to query the ports of the new instance 212. Typically, most network ports are associated almost universally with specific services. This allows many services to be discovered and characterized simply by analyzing responses from the ports.

In embodiments, the software allows the user to enter a list of credentials for each of one or more embedded monitoring agents or protocols (referred to herein generically as “embedded agents” or simply “agents”), such as WMI for Windows computers and SNMP for all network endpoints. The software then tests the new instance for each of the protocols by entering the corresponding credentials, and interrogates any agents which are found 214 for information regarding the configuration of the instance, including an inventory of services offered. Information regarding the embedded agent and any pertinent information obtained from the embedded agent is incorporated into the new monitoring configuration template.

In certain embodiments detection of embedded agents includes dynamic monitor pack detection, whereby the software enables the creation of “monitor packs,” each monitor pack corresponding to a certain type of embedded agent. In some embodiments the monitor packs are created using a specific XML syntax, and each monitor pack must include a “meta.xml” file. This file has detection parameters based on embedded agent protocol. During the automated configuration process, the software in these embodiments uses these detection criteria to assess the applicability of the monitor pack to each new instance created using a new image. When a match is found, the new monitoring configuration template includes the monitoring checks from the pack. Furthermore, in some embodiments the “meta.xml” file determines the format used by the process for output of the check command. Following is an XML code example:

<!--

Linux Server Health Pack. Wildcard * allowed for type and template.
For Linux, must support SNMP and be of type “Linux”.
Linux template is always “server” for now.

-->
<pack name=“Linux Health Pack” version=“1.00” protocols=“snmp”
devicetype=“*” type=“Linux”>
<servicegroup name=“Linux Server Health” type=“linux_memory”
template=“linux_memory”/>
<servicegroup name=“Linux Server Health” type=“linux_load”
template=“linux_load”/>
<servicegroup name=“Linux Server Health” type=“linux_disk”
template=“linux_disk”/>
<servicetemplate template=“linux_memory” description=“Memory_used_perc”
is_volatile=“0” max_check_attempts=“2” normal_check_interval=“5”
retry_check_interval=“2” notification_interval=“0” contact_groups=“admins”
command=“check_from_spore!check_mem_nix!20!/etc/silverspore/packs/linux/ch
eck_mem_nix.xml!85!95”/>
<servicetemplate template=“linux_load” description=“Load_avg_5_minutes”
is_volatile=“0” max_check_attempts=“3” normal_check_interval=“5”
retry_check_interval=“1” notification_interval=“0” contact_groups=“admins”
command=“check_from_spore!check_5min_load_nix!15!/etc/silverspore/packs/lin
ux/check_5min_load_nix.xml!4.0!10.0”/>
<servicetemplate template=“linux_disk” description=“Linux_/_disk_perc”
is_volatile=“0” max_check_attempts=“2” normal_check_interval=“15”
retry_check_interval=“5” notification_interval=“0” contact_groups=“admins”
command=“check_from_spore!check_disk_nix!_15!/etc/silverspore/packs/linux/che
ck_disk_nix.xml!85!95”/>
<detection oid_flag=“.1.3.6.1.4.1.2021.100.1.0”>
<service tcpport=“” description=“linux_memory”/>
<service tcpport=“” description=“linux_load”/>
<service tcpport=“” description=“linux_disk”/>
</detection>
</pack>

The <pack> section above specifies that the endpoint must support the SNMP protocol and the OS type must be Linux. The <detection> section specifies that if those conditions are met, the specific SNMP objectID .1.3.6.1.4.1.2021.100.1.0 must be accessible. If all of these conditions are met, three checks will be configured (each check is driven by a separate XML “command” file).

In the embodiment of FIG. 2, the software implemented method also polls the cloud controller 200 to determine if any instances have been terminated 220. If so, then the monitoring of the terminated instance(s) is ended without issuing any alerts 222. If this did not happen automatically, the user would be flooded with false alerts as host and service monitoring checks failed.

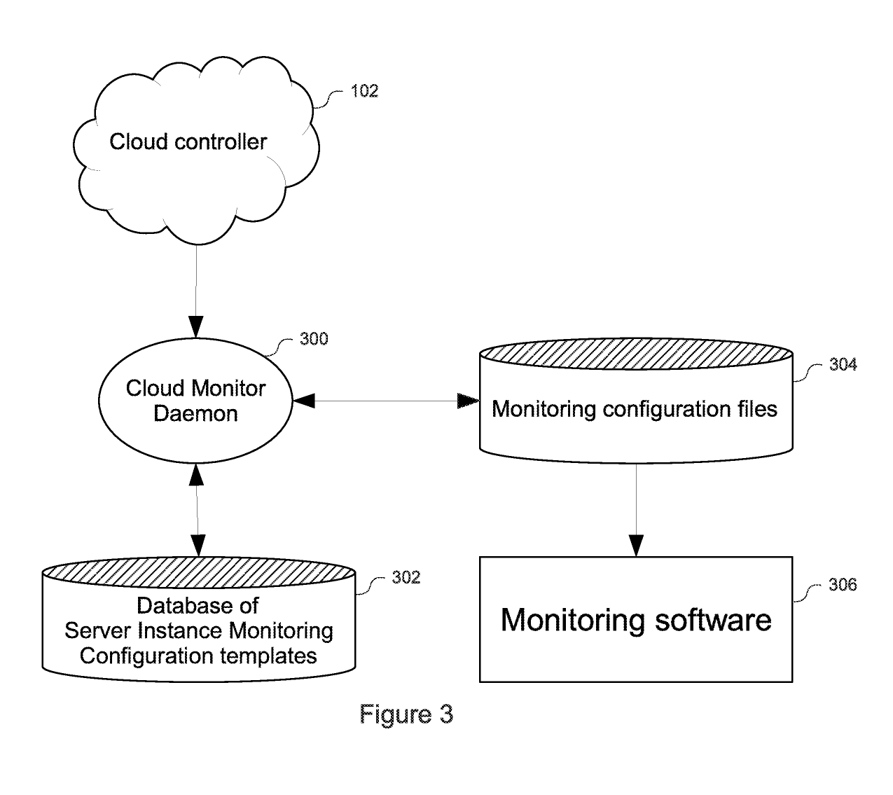

FIG. 3 illustrates the components of an embodiment of the present invention and their interaction with a cloud infrastructure and a monitoring system. The embodiment includes a cloud monitor daemon 300 which polls the cloud controller 102. In some embodiments the cloud is an Amazon cloud, and the controller 102 can be polled using the Amazon EC2 API. When a new instance is created, the monitor daemon 300 obtains the image ID for the new instance from the cloud controller 102 and compares it with the monitoring configuration templates in the template database 302. As discussed above, if a matching template is not found, the system initiates a discovery process and creates a new monitoring configuration template, which is added to the database 302. The monitoring configuration template is then used to create a monitoring configuration for the new instance, and the monitoring configuration is added to a collection of active monitoring configuration files 304 used by the monitoring software 306. When the cloud monitoring daemon 300 detects that an instance has been terminated, the corresponding monitoring configuration is removed from the collection of active monitoring configuration files 304.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. Non-transient media comprising software which, when executed on a computing system, causes the computing system to execute steps leading to creation of a monitoring configuration usable by a monitoring system for monitoring an instance in a cloud computing network, the instance being created by a cloud controller according to an image or provisioning template, the steps executed by the computing system under control of the software comprising:
maintaining a database of monitoring configuration templates, each monitoring configuration template being associated with an image or provisioning template;
obtaining from the cloud controller information indicating that a new instance has been created using an image or provisioning template;
obtaining from the cloud controller information identifying the image or provisioning template used for creating the new instance;
determining if any of the monitoring configuration templates stored in the database of monitoring configuration templates is associated with the image or provisioning template used for creating the new instance;
if none of the monitoring configuration templates stored in the database of monitoring configuration templates is associated with the image or provisioning template used for creating the new instance:
creating a new monitoring configuration template;
associating the new monitoring configuration template with the image or provisioning template used for creating the new instance; and
adding the new monitoring configuration template to the database of monitoring configuration templates;
using the monitoring configuration template that is associated with the image or provisioning template used for creating the new instance to create a monitoring configuration associated with the new instance; and
providing the monitoring configuration associated with the new instance to the monitoring system.

2. The media of claim 1, wherein the information identifying the image or provisioning template used for creating the new instance includes an image ID or provisioning template ID.

3. The media of claim 1, wherein the steps further comprise obtaining from the cloud controller at least one of a private and a public IP address assigned to the new instance.

4. The media of claim 3, wherein creating a monitoring configuration for the new instance includes inserting the IP address into the monitoring configuration template that is associated with the image or provisioning template used for creating the new instance.

5. The media of claim 1, wherein the steps further comprise:
obtaining from the cloud controller information indicating that an instance has been terminated; and
removing the monitoring configuration associated with the terminated instance from the monitoring system, thereby avoiding an issuing by the monitoring system of a false alert regarding the terminated instance.

6. The media of claim 1, wherein creating a new monitoring configuration template includes providing to the computing system by a user of information regarding the image or provisioning template used for creating the new instance.

7. The media of claim 1, wherein creating a new monitoring configuration template includes using a discovery process to automatically discover information regarding the new instance.

8. The media of claim 7, wherein the discovery process includes querying ports of the new instance and analyzing responses therefrom.

9. The media of claim 7, wherein the discovery process includes detecting an embedded agent running on the instance and obtaining configuration information from the embedded agent.

10. The media of claim 9, wherein detecting the embedded agent includes receiving from a user credentials for the embedded agent and submitting the credentials to the new instance.

11. The media of claim 9, wherein the embedded agent is an SNMP agent.

12. The media of claim 9, wherein the embedded agent is a WMI agent.

13. The media of claim 9, wherein the embedded agent is a ws-man agent.

14. The media of claim 9, wherein the embedded agent is a CIM/SMASH agent.

15. The media of claim 9, wherein the embedded agent is a proprietary agent.

16. The media of claim 7, wherein the steps further comprise:
maintaining at least one monitor pack, the monitor pack including detection criteria useful for detecting an embedded agent running on an instance, the monitor pack further including checks useful for interrogating the embedded agent if it is found;
using the monitor pack to determine if the embedded agent is running on the new instance; and
if the embedded agent is running on the new instance, incorporating the monitor pack checks into the new monitoring configuration template.

17. The media of claim 1 wherein communicating with the cloud controller includes using an API.

18. The media of claim 17, wherein the API is the Amazon EC2 API.
